(19) United States
(12) Patent Application Publication
(10) Pub. No.: US 2003/0091176 A1
(43) Pub. Date: May 15, 2003

(54) Communication system and method for establishing an internet connection by means of a telephone

(76) Inventors: Stefan Feldes, Pfungstadt (DE); Bernd Lochschmidt, Brensbach (DE)

Correspondence Address: DAVIDSON, DAVIDSON & KAPPEL, LLC, 485 SEVENTH AVENUE, 14TH FLOOR, NEW YORK, NY, 10018, US

(21) Appl. No.: 10/149,459

(22) PCT Filed: Nov. 29, 2000
(86) PCT No.: PCT/EP00/11933

(30) Foreign Application Priority Data
Dec. 10, 1999 (DE) 199 58 850.9

(51) Int. Cl. H04M 7/00; H04M 1/64

(52) U.S. Cl. 379/220.01; 379/88.01; 379/88.17

(57) ABSTRACT

The present invention relates to a communication system and a method for providing a communication connection between a telephone user and an information server. The communication system includes a first communication network (10) to which a plurality of telephones (15) can be connected, and a second communication network (20), in particular, the internet, to which at least one server (25) containing retrievable graphic and/or textual representations, can be connected. The object of the present invention is to provide a communication system and a method which permit a customer an acoustic, in particular, spoken access, via a telephone, to a server which is connected, in particular, to the internet and which provides graphic and/or textual information. For this purpose, the communication network features a connection device (30) which interconnects the first and second communication networks (10; 20). Moreover, the connection device (30) includes a conversion device (100) for converting at least a part of a loaded graphic and/or textual representation into a corresponding acoustic representation for transmission to the telephone (15).

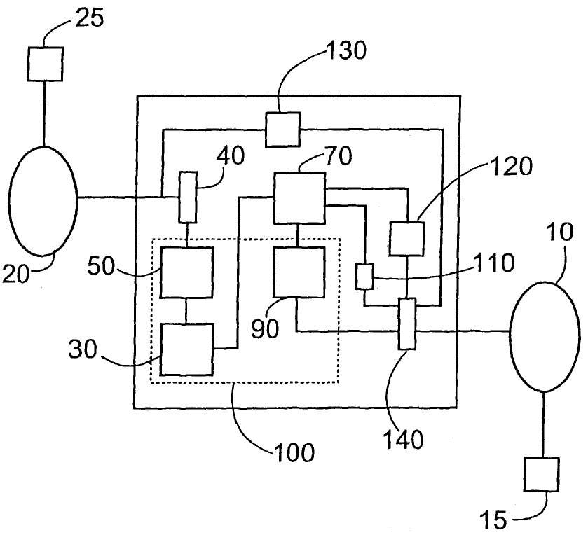

The present invention generally relates to a communication system and a method for providing a communication connection between a user of a telephone which is connected to a first communication network and a server which is connected to a second communication network, and to a method which can be carried out by the communication system. In particular, the present invention relates to a communication system and a method for providing access to the internet via a telephone.

More and more information suppliers, also called content providers, are publishing their information contents in the form of web pages in the internet.

In known methods heretofore, however, only customers who are connected to the internet via a computer with a suitable online connection have been able to access web pages. However, a large part of potential customers does not have a computer and therefore cannot be reached via the internet.

Therefore, the object of the present invention is to provide a communication system and a method which permit a customer an acoustic, in particular, spoken access, via a telephone, to a server which is connected, in particular, to the internet and which provides graphic and/or textual information.

The central idea of the present invention is to be seen in that graphic and/or textual information contents which are provided by servers which are connected to a communication network (for example, the internet) are acoustically output via a telephone which is connected to another communication network such as the public telephone network.

The technical problem mentioned above is solved by the present invention, on one hand, with the features of claim 1.

Accordingly, provision is made for a communication system including a first communication network to which a plurality of telephones can be connected and a second communication network, in particular, the internet, to which at least one server containing retrievable graphic and/or textual representations, can be connected. If the servers, which will hereinafter be referred to as information servers, are connected, for example, to the internet, it is possible for the retrievable graphic and/or textual representations to be web pages which are written, for example, in HTML (Hypertext Markup Language).

To permit a customer access to an information server via a telephone, the first and second communication networks are connected via a connection device. The connection device includes a device for recognizing commands and/or control information which are input via a telephone as well as a storage device for storing a graphic and/or textual representation which has been retrieved from the information server in response to an input command and/or a control information item. To enable the graphic and/or textual representation to be acoustically reproduced to the user via the telephone, provision is made for a conversion device for converting at least a part of the graphic and/or textual representation stored in the storage device into the corresponding acoustic representation for transmission to the telephone.

At this point, it should be mentioned that the commands which can be input by the user are a predetermined set of command words such as “help”, “start page”, etc. and that the control information which can be input can be jump or branch addresses which need not be known a priori.

To be able to obtain from the graphic and/or textual representation an acoustic representation which is useful for the user, the conversion device has an extraction device, for example, a so-called “parser” for the extraction of the information contents which are able to be converted into the acoustic representation, of markings and/or of control parameters from the stored graphic and/or textual representation. A so-called “interpreter” serves to identify and translate the extracted information, markings and/or control parameters in such a way that both the translated information and the translated control parameters can be converted into the corresponding acoustic representation in a synthesizer. At this point, it should be mentioned that the control parameters can contain, for example, jump or branch addresses which correspond to so-called “links”. The acoustic form of representing the control parameters are words or phrases which can correspond to control information items which can be input by the user via the telephone. For instance, a control parameter can also represent a term to which are assigned several jump or branch addresses which are known to the user, without the need for these jump or branch addresses to be separately read to the user.

To permit interactive communication between the telephone user and the information server, provision is made for a device for controlling the dialog between the telephone user and the information server. The dialog control device can be controlled with the control parameters obtained from the stored graphic and/or textual representation on one hand and, on the other hand, with the commands and control information items which are input by the user. For instance, the dialog control device can provide predetermined texts to the user in response to predetermined control parameters or control information items.

Commands and control information can be input by the user via the telephone in spoken form or via the keypad using a multifrequency dialing method. For this purpose, the device contains a speech recognition device and/or a multifrequency detector to recognize commands and/or control information which are input via the telephone. Using the speech recognition device and the acoustic synthesizer, it is possible to accomplish an interactive communication connection between the telephone user and the information server on a purely spoken level.

To increase the quality of the synthesizer and of the speech recognition device, provision can be made for a first storage device for storing a system-specific phonetic lexicon, for a second storage device for temporarily storing a phonetic lexicon appertaining to a graphic and/or textual representation and/or for a third storage device in which each information supplier can store an individual phonetic lexicon of his/her own in updatable form. The phonetic lexicon can be contained in the specific graphic and/or textual representation or be activated in the connection device and made available to the synthesizer in response to a predetermined control parameter. A phonetic lexicon contains, for instance, all the jump or branch addresses in word form which are contained in a graphic and/or textual representation as well as the description of their pronunciation so that these words can be spoken to the telephone user clearly and distinctly and, respectively, that the verbal utterances of the user can be reliably recognized.

To enable control information items which are input by the user in the form of words or sentences to be recognized by the speech recognition device with high quality, a storage device in which spoken control information and spoken commands can be stored is assigned to the speech recognition device. The content of the storage device determines the search space for the speech recognition device.

The speech recognition device, which is known per se, can use, for example, the so-called “keyword spotting” and/or “key-phrase spotting” to allow the relevant part, for example, only the spoken control information, to be extracted from an utterance.

To permit as user-friendly as possible an interaction with the information server, making allowance for the limited acoustic receptivity of the user, the graphic and/or textual representation is acoustically output or “read” in sections. The division of the graphic and/or textual representation retrieved from the server into a plurality of sections of predetermined length is carried out by the extraction device in conjunction with the interpreter and the dialog control device by obtaining suitable markings from the graphic and/or textual representation and processing them. The dialog control device can generate an end text for each section, the end text containing, for example, all jump and branch addresses contained in the respective section.

At this point, it should also be indicated that the speech dialog control device can be designed in such a manner that the jump or branch addresses (so-called “links”) contained in the graphic and/or textual representation are “read” to the user in groups if the jump or branch addresses exceed a predefined number. If a plurality of jump or branch addresses are known to the user from the context of an acoustically output graphic and/or textual representation, the dialog control device ensures that only a general reference to these jump or branch addresses is read to the user without the need for these jump or branch addresses to be read to him/her separately.

To be able to specifically select an information server from a telephone, the connection device is provided with a storage device in which the current call numbers and the associated IP addresses of the respective information servers are stored.

The technical problem mentioned above is also solved with the method steps of claim 11.

Accordingly, provision is made for a method according to which initially, a connection establishment to an information server is initiated by entering a call number on a telephone. Subsequently, the user requests, via the telephone, a graphic and/or textual representation from the selected information server. All inputs into the telephone can made by voice or with the aid of multifrequency signals via a keypad. In response to the request, the desired graphic and/or textual representation is first loaded into a connection device which connects the first and second communication networks. In the connection device, at least a part of the stored graphic and/or textual representation is converted into a corresponding acoustic representation and transmitted to the telephone. Finally, the received acoustic representation is acoustically output to the telephone user.

Advantageous refinements are the subject matter of the subclaims.

Besides pure text passages which only need to be read, a graphic and/or textual representation can also contain forms to be filled out by the user, the form fields to be filled out being marked by corresponding control parameters. These control parameters obtained from the graphic and/or textual representation contain, for example, information on the positions of the form at which entries can be made. Expediently, the voice request to fill out the form occurs stepwise, that is, each input field is queried and filled out by the user with corresponding entries successively in time. These inputs are transmitted via the connection device to the information server and placed there automatically at the correct positions within the form.

Moreover, the author can insert control parameters into the graphic and/or textual representation which contain, for example, the address of an audio file (of a radio play, pieces of music, etc.) whose content is indeed not output in the graphic and/or textual representation but which is called up and acoustically output via the telephone upon request by the user.

In the following, the present invention will be explained in greater detail in the light of an exemplary embodiment in conjunction with the attached drawing.

The FIGURE shows a communication system including, for example, a public telephone network 10 and the internet 20 which are connected via a connection device 30, also referred to as gateway. As shown in the FIGURE, connection device 30 is connected to public telephone network 10 via a telephone interface 140. A plurality of telephones, of which only telephone 15 is shown, are connected to public telephone network 10. Similarly, a plurality of information servers 25 of different content providers are connected to internet 20 of which, in turn, only information server 25 is shown for the sake of a simpler representation.

The main function of connection device 30 is to interconnect internet 20 and public telephone network 10 in such a manner that at least one essentially speech-based communication connection between a telephone connected to public telephone network 10 and an information server connected to internet 20 can be established. To this end, connection device 30 is to be implemented in a manner which enables at least a part of a graphic and/or textual representation which is stored, for example, on information server 25 to be acoustically reproduced to the customer via telephone 15. In this context, the graphic and/or textual representations are stored on the information servers, for example, as web pages.

Specifically, connection device 30 features a storage device 40 into which a web page can be currently loaded from information server 25. Besides text and picture contents, the web page usually also contains markings and control parameters which are inserted by the content provider and which can be used for the acoustic conversion of the web page as will be explained in greater detail further below. The markings within a web page serve, for example, to mark the start and the end of a text passage which can be output to the user in spoken form via telephone 15, or to mark the start and end points of a picture component which cannot be acoustically read to the user. The control parameters contain, for example, jump or branch addresses which correspond to the names of all links within a web page. The web page which is temporarily stored in storage device 40 is fed to a parser 50 and to an interpreter 60. Parser 50 is known per se and used to extract the information which is convertible into an acoustic representation from the loaded web page with the aid of markings which are embedded in the web page. Besides the actual text passages which can be read to the user via telephone 15, parser 50 extracts from the stored web page also the control parameters which are fed to interpreter 60 together with the extracted text passages and the markings. Interpreter 60 has the task of identifying the extracted text passages, markings and/control parameters, and of translating or converting them according to a predetermined set of rules. The translated text passages and control parameters are applied to the input of a dialog control device 70 which is connected to a synthesizer 90. Using synthesizer 90, the text passages which have been translated by interpreter 60 are converted into the corresponding acoustic representation. Moreover, synthesizer 90 converts the translated control parameters, for example, into corresponding names of current links to which one can branch from the web page. In conclusion, parser 50, interpreter 60 and synthesizer 90 constitute a conversion device 100 which generates from a loaded web page an acoustic equivalent which serves as the basis for a voice dialog with the customer.

Moreover, connection device 30 features a speech recognition device 110 which is able to recognize the spoken inputs of the user via telephone 15 and to convert them into the corresponding text.

Connection device 30 further has a data base 130 in which are stored the current call numbers and associated IP addresses of the information servers with the aid of which the customer can establish a connection to a desired information server, for example, to information server 25, via telephone 15.

With the assistance of the communication system, it is possible to make web pages available to a telephone customer in acoustic form, without the customer needing a personal computer for displaying the web page. Moreover, the communication system can be extended in a simple and cost-effective manner by connecting further information servers. For this, it is only necessary that the corresponding call numbers and IP addresses of the newly added information servers be stored in data base 130. This has the advantage for the content provider of an information server that he/she can create new web pages using usual tools and methods, it being possible then to acoustically output the new web pages to a customer via connection device 30. The advantage for the service provider who is responsible for telephone network 10 and connection device 30 is that he/she can offer his/her customers new web pages in spoken form without the need for software-related changes or circuit changes in connection device 30.

In the following, the mode of operation of the communication system will be described in greater detail by way of a scenario.

For this purpose, it is assumed that the user of telephone 15 wants to have verbally read to him/her an information item which is stored on information server 25. In the present example, the user initially dials the call number of information server 25 for this purpose. A switching exchange of public telephone network 10 which switching exchange is assigned to the customer recognizes the call number as an address of an information server and forwards the call number to connection device 30. In connection device 30, the call number is recognized, for example, by telephone interface 140 and fed, as a storage address, to data base 130 from which the IP address of information server 25 assigned to the dialed call number is read out. The IP address which has been read out is then used to establish a connection to information server 25 via internet 20. Now, an interactive communication connection exists between the user of telephone 15 and information server 25, it being possible for the interactive communication connection to be of purely spoken nature.

Initially, the start page of information server 25 is loaded into storage device 40. Subsequently, the text contents to be read to the user of telephone 15 together with the control parameters contained on the start page are extracted from the start page in parser 50 and fed to interpreter 60. As already mentioned above, interpreter 60 translates the extracted text contents and control parameters and transmits the translated text contents and control parameters to dialog control device 70. Dialog control device 70 ensures that synthesizer 90 first converts the text-relevant passages of the start page into a corresponding acoustic representation and transmits it to telephone 15 via telephone interface 21. In this manner, the text content of the start page can, so to speak, be “read” to the user via telephone 15. Subsequently, the corresponding acoustic representations of the control parameters, which constitute, for example, the names of predetermined links (also referred to as branch options), are converted in synthesizer 90 and, again, read to the user via telephone 15. Should the number of branch options exceed a predetermined limit value, dialog control device 70 can ensure that the branch options are read to the user in groups, it being easier for the user to remember the branch options in this manner. After the branch options have been read, the user can input a branch option in spoken form via telephone 15. The spoken branch option is recognized in speech recognition device 110, converted into the corresponding text and transmitted to information server 25 via dialog control device 70. In the present case, the branch option reads, for example, “Federal Dept Administration”, whereupon the corresponding web page is loaded from information server 25 into storage device 40 in the next cycle. This web page has, for example, the following content which will be reproduced in the form of extracts:

“Welcome to the Federal Debt Administration.

The Federal Debt Administration is an independent Federal higher authority within the sphere of responsibility of the Federal Ministry of Finance.

Its core task is to ensure the notarial recording of the borrowings of the Federal Government and of its special assets on the capital market and to ensure bank-like administration and settlement of the loans.”

In the present section of the web page, the underlined terms constitute control parameters which are inserted by the creator of the web page and which correspond to branch options. Moreover, the section contains a plurality of markings (not shown) which, on one hand, mark the present extract as a text passage which contains two paragraphs. Accordingly, parser 50 extracts from the web page the text passages to be represented acoustically, the start and end marks of each paragraph as well as the control parameters. Interpreter 60 identifies the markings, the control parameters and the text sections and, with the aid of a set of rules, translates them into a form processible by dialog control device 70. In a particular embodiment, it is possible for interpreter 60 to take the paragraphs of the text passage as separate information packets which are to be processed independently of each other. Initially, dialog control device 70 feeds the first paragraph “Welcome to the Federal Debt Administration . . . of Finance.” to synthesizer 90 under the control of interpreter 60, the synthesizer generating the corresponding acoustic representation from the text and transmitting this acoustic representation via public telephone network 10 to telephone 15. The paragraph is read to the user in spoken form via telephone 15. Subsequently, interpreter 60 controls the dialog control device in such a manner that, besides the branch options “Federal Debt Administration” and “Federal Ministry of Finance”, the prompt “next” is also fed to synthesizer 70. Then, dialog control device 70, interacting with synthesizer 90, generates the following spoken information to be output via telephone 15: “Your options are: Federal Debt Administration, Federal Ministry of Finance or next ?”

Now, the user can choose between the three terms and verbally input one of the terms via the telephone. For example, the customer inputs the term “next” via telephone 15. In response to the input term “next”, dialog control device 90 ensures that the second paragraph of the loaded web page is now fed to synthesizer 90. Upon conversion of the second text paragraph into the corresponding acoustic representation, the following content is read via telephone 15:

“Its core task is to ensure the notarial recording of the borrowings of the Federal Government and of its special assets . . . and settlement of the loans.”

Moreover, dialog control device 70 causes the control parameters “notarial recording”, “borrowings”, “special assets”, and “next”, which are contained in this paragraph, to be fed to the synthesizer which, in turn, generates corresponding acoustic representations of these words which are read to the user. To enable a further paragraph of the web page to be read, the user would have to input the word “next” again. However, if he/she selects one of the branch options “notarial recording”, “borrowings”, “special assets”, dialog control device 70 ensures that the corresponding web page is loaded from information server 25 into storage device 40. The procedure is repeated until the user releases the connection to information server 25 via telephone 15, for example, by the spoken input “end”. The connection can also be automatically released by connection device 30 if a web page has no further branch options at the end.

To improve the quality of synthesizer 90 and of speech recognition device 110, for example, the branch options contained in the currently loaded web page as, for instance, “notarial recording”, “borrowings”, “special assets”, or words of foreign origin or abbreviations can be stored in a storage device (not shown) which is assigned to synthesizer 90 and to speech recognition device 110 and which, in addition to the actual word, contains the appertaining description of the pronunciation as well.

Moreover, all commands and branch options which are offered to the user and which are available in connection with a currently loaded web page can be loaded into a storage device assigned to speech recognition device 110. By using updatable storage devices, the number of concurrently activated words and phrases can be kept low which makes it possible for the processing speed and for the speech recognition capacity of connection device 30 to be increased.

Besides web-page dependent commands, system-defined commands such as “help”, “start page”, “repeat”, “back”, “next” can also be made available to the user.

To allow the author of a web page to selectively control the acoustic representation of the web pages, it is possible to insert into the web pages further control parameters in the form attributes which are only interpreted by the connection device but ignored by standard browsers of the internet.

Attributes of that kind are, for example:

“Start”

This attribute is interpreted by the parser and the interpreter as a marking at which the conversion of the web page into the corresponding acoustic representation is started. All contents before this mark are not converted.

“Ignore Begin# Ignore End#”

By way of these markings, the parser and the interpreter recognize an area which is not intended for audible representation but which is to appear, for example, in the visual browser.

“Alt Audio”

By this marking, the parser and the interpreter recognize a file name under which, for example, an audio file is stored which is to be acoustically output to the user via telephone 15.

“AltText”

This attribute is recognized by the parser and the interpreter to acoustically output, via the telephone, a text which corresponds, for example, to a description of a picture component.

A further feature of connection device 30 can be that dialog control device 70 automatically signals an error to the user of telephone 15 if speech recognition device 110 has not properly recognized a word or a phrase. For this purpose, dialog control device 90 can be designed such that, in the case of an error, it repeatedly prompts the user to input a command or a branch option.

What is claimed is:

1. A communication system for providing a communication connection between a user of a telephone (15) and a server (25), having
a first communication network (10) to which a plurality of telephones can be connected,
a second communication network (20), in particular, the internet, to which at least one server (25) containing graphic and/or textual representations can be connected, and
a connection device (30) for connecting the first communication network (10) to the second communication network (20),
comprising
a device (110, 120) for recognizing commands and/or control information which are input via a telephone (15),
a storage device (40) for storing a graphic and/or textual representation which has been retrieved from a server (25) in response to the commands and/or control information,
a conversion device (100) for converting at least a part of the graphic and/or textual representation stored in the storage device (40) into a corresponding acoustic representation for transmission to the telephone (15).

2. The communication system as recited in claim 1,
wherein the conversion device (100) has
an extraction device (50) for the extraction of the information which is able to be converted into the acoustic representation, of markings and/or of control parameters from the stored graphic and/or textual representation,
a device (60) for identifying and translating the extracted information, markings and/or control parameters, and
a synthesizer (90) for converting the translated information and control parameters into a corresponding acoustic representation.

3. The communication system as recited in claim 1 or 2,
wherein the connection device (30) has a device (70) for controlling the dialog between the telephone user and the server.

4. The communication system as recited in claim 3,
wherein the dialog control device (70) is designed to provide predetermined texts to the user.

5. The communication system as recited in one of the claims 1 through 4,
wherein the device for recognizing (110, 120) commands and/or control information which are input via the telephone contains a speech recognition device (110) and/or a multifrequency detector (120).

6. The communication system as recited in claim 5,
characterized by
a first storage device for storing a system-specific phonetic lexicon,
a second storage device for temporarily storing a phonetic lexicon appertaining to a graphic and/or textual representation and/or
a third storage device for storing, in updatable form, at least one phonetic lexicon of an information supplier,
the first, second and/or third storage device being assigned to conversion device (100) and to speech recognition device (110).

7. The communication system as recited in claim 5 or 6,
characterized by a storage device which is assigned to the speech recognition device (110) and used for storing spoken control information items which are assigned to control parameters and for storing spoken commands.

8. The communication system as recited in one of the claims 1 through 7,
wherein each graphic and/or textual representation which is retrievable from the server (25) corresponds to a web page.

9. The communication system as recited in one of the claims 1 through 8,
wherein the extraction device (50) is designed for dividing the graphic and/or textual representation retrieved from the server into a plurality of sections of predetermined length.

10. The communication system as recited in one of the claims 1 through 9,
characterized by a storage device (130) for storing, in updatable form, call numbers and associated IP addresses of the respective servers.

11. A method for providing a communication connection between the user of a telephone and an information server via a communication system according to one of the claims 1 through 9, the communication system having a first communication network (10) to which a plurality of telephones (15) can be connected, a second communication network (20) to which at least one server (25) containing retrievable graphic and/or textual representations can be connected, and a connection device (30) which interconnects the first and second communication networks, comprising the following method steps:
a) initiation of a connection establishment to a server (25) via a telephone (15);
b) request of a graphic and/or textual representation via the telephone;
c) loading of the requested graphic and/or textual representation into the connection device;
d) conversion of at least a part of the graphic and/or textual representation stored in the connection device (30) into a corresponding acoustic representation;
e) transmission of the acoustic representation to the telephone; and
f) acoustic output of the acoustic representation via the telephone.

12. The method as recited in claim 10,
wherein
step c) includes the step of obtaining one or more control parameters from the loaded graphic and/or textual representation;
the control parameters are translated and subsequently verbally output via the telephone;
the user is verbally prompted to input at least one of the control parameters via the telephone;
the conversion of the graphic and/or textual representation into a corresponding acoustic representation is continued at a predetermined position as a function of the at least one input control parameter;
a further graphic and/or textual representation is loaded into the connection device, or the established connection to the server is terminated.

13. The method as recited in claim 11,
wherein the loaded graphic and/or textual representation includes a form to be filled out, and the obtained control parameters contain spoken instructions and prompts for filling out the form.

14. The method as recited in claim 11 or 12,
wherein the obtained control parameters contain addresses for loading an audio file which is acoustically output via the telephone.

15. The method as recited in claim 10 or 11,
wherein a user inputs commands and/or control information via the telephone in spoken form or using a multifrequency dialing method.

16. The method as recited in one of the claims 10 through 15,
wherein
the loaded graphic and/or textual representation is divided into sections of predetermined length;
at least a part of each section is converted into the corresponding acoustic representation; and
the sections are transmitted to the telephone successively in time.

17. The method as recited in claim 16,
wherein at the end of each section, the connection device generates a predetermined text which is output via the telephone.
